(19) United States
(12) Patent Application Publication
(10) Pub. No.: US 2005/0181230 A1
(43) Pub. Date: Aug. 18, 2005

(54) Corrosion resistant, zinc coated articles

(76) Inventor: Martin L. Straus, Chicago, IL (US)

Correspondence Address: Garrettson Ellis;Seyfarth Shaw LLP, Suite 4200, 55 East Monroe Street, Chicago, IL, 60603, US

(21) Appl. No.: 10/780,506

(22) Filed: Feb. 17, 2004

(51) Int. Cl. B05D 3/00; B05D 7/00; B32B 15/00

(52) U.S. Cl. 428/658; 427/299; 427/402; 427/430.1

(57) ABSTRACT

A zinc or zinc/alloy surface of a metal artifact is protected by passivating or activating the surface with a solution comprising an oxidizing acid or activating acid; applying to the surface an aqueous priming solution of an alkali metal permanganate in the presence of halogen ions, with the solution having a pH of about 1 to 8; and then further applying to the surface an aqueous sealing solution such as a lithium silicate and a sodium or potassium silicate solution. Strong corrosion protection can be achieved. Improvements may also be obtained with the addition of a rare earth salt to the priming solution.

### BACKGROUND OF THE INVENTION

Parts made of iron or steel have been traditionally protected against rusting by applying a coating of a sacrificial metal such as cadmium or zinc. Cadmium is no longer commercially used for this purpose due to its toxicity. Today, zinc is applied by various methods, such as hot dip galvanizing, mechanical plating (Peen Plate), zinc rich paint, or electrogalvanizing. Electrogalvanizing or zinc plating is the preferred way to protect steel articles from rusting by the automotive and appliance industries. In addition to zinc, there is now a widespread movement to utilize various zinc alloys to enhance the corrosion protection properties of zinc. Common alloys are zinc/nickel, zinc/iron, zinc/aluminum, and zinc/cobalt.

The zinc or zinc alloy layer has a tendency to quickly corrode when exposed to the elements. When zinc or its alloys corrode, they form very distinct white corrosion products, which are commonly referred to as “white rust” or “aspect corrosion”. In order to retard the formation of this white corrosion, industry has heavily relied upon the use of hexavalent chromium compounds, which are termed generically as “chromates”. The corrosion protection of these chromates is evaluated by subjecting plated/chromated articles to a continuous salt fog environment which has been standardized as ASTM B 117. The numbers of hours are noted when the first signs of white corrosion appear, usually around 5%. Various types of chromates have been employed, which result in different levels of corrosion protection, with each level associated with also a color:

| | |
|---|---|
| Blue/Clear | 5-10 hours |
| Yellow/Iridescent | 96-150 hours |
| Olive Drab | 150-250 hours |

Not only do these compounds protect the zinc or zinc alloys from white rust, they protect the coating from physical abuse. When a chromate is scratched, it has a tendancy to repair itself by exuding trapped, hydrated chrome in the surrounding chromate coating.

These chromium compounds are very easy and economical to apply. Unfortunately, they are toxic because they contain copious amounts of hexavalent chromium, a known cancer causing agent, and their use is being phased out, especially in the automotive industry both in the US and Europe. As an example, General Motors has issued a new, worldwide specification for zinc plating: GMW 3044, which clearly mandates that no hexavalent chromium compounds are to be permitted. The specification calls for, among other things, a yellow/iridescent passivation that must withstand 120 hours of salt spray. The specification does allow for the less toxic form of chromium to be used, i.e. trivalent chromium. Additionally, because trivalent passivations do not self-heal when damaged, a silicate topcoat is required to help protect the fragile passivation layer.

However, in a study published by Dr. Anderle of Atotech, Germany, a supplier of trivalent passivation, it was reported that the corrosion resistant trivalent coatings form hexavalent chromium over time by oxidation. Dr. Anderle also demonstrates that by post baking this side reaction can be very much be slowed down. It is obvious that the only way to eliminate all possibility of forming toxic, hexavalent chromium compounds is to avoid the use of any chromium compound whatsoever.

It is an object of this invention to provide one or preferably all of the following to a corrosion-resistant coating:
1. A yellow/iridescent passivation for zinc and zinc alloys which closely resembles that of the traditional, yellow hexavalent chromates, but which contains no chromium;
2. A yellow/iridescent passivation which will afford 120 hours of salt spray protection to white rust when subjected to ASTM B117;
3. A yellow/iridescent, chromium free passivation that will not interfere with the threads of fasteners or recesses in the heads by being too thick, as can occur with the use of paint;
4. A yellow/iridescent passivation which will impart the desired friction coefficient to threaded products as required by automotive specifications such as GMW 3044 and Ford Motor specification WZ 101;
5. A yellow/iridescent, chromium free passivation/sealer system which can be applied by the existing equipment that is used now for the application of the hexavalent, yellow chromates;
6. A yellow/iridescent, chromium free passivation/sealer system which is free of toxic fluorides;
7. A yellow/iridescent passivation/sealer system which is free of chelating agents that can interfere with wastewater treatment facilities used in finishing plants today;
8. A yellow/iridescent, chromium free passivation/sealer system which requires no heat for curing;
9. A yellow/iridescent, chromium free passivation/sealer system which is economical to use;
10. A yellow/iridescent, chromium free passivation/sealer system which will withstand the rigors of assembly and still be effective as an anti-corrosion finish;
11. A yellow/iridescent, chromium free passivation/sealer system that contains no silicone compounds;
12. A yellow/iridescent, chromium free passivation/sealer system which can be very quickly applied to maintain the production capacity of existing equipment.

### DESCRIPTION OF THE INVENTION

By this invention, strong corrosion protection can be provided, while achieving the above objects of the invention.

Specifically, a method is provided for protecting a zinc surface of a metal artifact, such as a screw, bolt, nut, bracket, or other component of an automobile, home appliance, industrial machinery, or any other desired use.

The term “zinc” may include zinc alloys, such as those listed above.
1. As a first step, the zinc surface of the metal artifact is passivated with an oxidizing acid passivation solution by forming an oxide coating, for example, nitric acid, oxalic acid, persulfuric acid, or similar, known acidic passivation materials, including mixtures thereof, typically at a pH of about 1 to 4, and preferably about pH 1 to 1.5 or 2. Alternatively, the zinc surface is activated (apparently by removal of essentially all residual surface oxides) with an activating solution comprising inorganic acids such as HCl or H₂SO₄, or organic acids, such as acetic acid, or mixtures thereof;
2. Then, there is applied to the zinc surface an aqueous priming solution of an alkali metal permanganate in the presence of halide, for example, as provided by sodium chloride or aluminum chloride, the solution having a pH of about 1 to 8.
3. After allowing the metal artifact to dry, one further applies to the surface thereof an aqueous sealing solution, such as a solution of a lithium silicate and another alkali metal silicate, plus optionally a promoter, such as molybdic acid. Another sealing solution that may be used is an organosilane solution such as that disclosed in Kunz, et al U.S. Pat. No. 6,478,886.

Superior corrosion resistance has been achieved with such a method and coating, in which the corrosion resistance of metal artifacts treated as above exceeds the corrosion resistance of metal artifacts treated with only one or two of the above steps. Typically, the metal artifacts are immersed in the respective solutions typically rinsed with cold water except after the sealing step, and allowed to dry between immersions. Steps 1 and 2 may be combined as a single solution, using a single immersion step. Also, it is generally preferred for the pH of the priming solution to be about 1.5 to 5.

Without wishing to be limited by theory, activating solutions that remove essentially all oxide and passivating solutions that form an oxide film are both more effective than an apparent middle ground situation of partial surface oxidation that exists without such treatment.

While, as stated above, the halide is preferably chloride, and provided by ionic salts that dissociate to provide chloride ion in the solution, it is believed that sodium bromide and other halide salts are useable in the process as well, as equivalent materials. The halide ion may be provided to the aqueous priming solution in the form of an alkali metal chloride such as sodium chloride or potassium chloride. However, it is believed that a wide variety of halogen salts may also be utilized as the halogen source, such as calcium chloride, calcium bromide, magnesium chloride, aluminum chloride, magnesium bromide, sodium iodide, and the like.

In the second step of application of the aqueous priming solution, it is generally preferred for the alkali metal permanganate to be sodium permanganate or potassium permanganate. Preferably, about 0.3 gm-120 gm per liter of such permanganate may be used, generally without a particular, critical upper limit.

While all the three steps of the method of this invention may be performed at generally room temperature (about 50-80° F.), if desired the priming solution may be heated to about a temperature of 100°-180° F. Generally, the temperature of operation of the various steps of solution application is not critical, although there may be some effect on the optimum time period for dipping the artifacts in the various solutions, and the like. Preferably, the priming solution is applied to the metal artifact by dipping each metal artifact into the solution for at least five seconds, and preferably about 10-30 seconds.

The aqueous sealing solution may preferably comprise a solution of a lithium silicate and a sodium and/or potassium silicate in such concentration that the sealing solution has about 5-20 weight percent of SiO₂, in which each of the lithium and the sodium/potassium silicate ingredients contribute at least 10 percent of the SiO₂ present in the solution. Optionally, from 0.2 to 0.5 gram per liter of molybdic acid, which serves as promoter, may be present.

It is also often preferable for silicone defoamers, inorganic or organic silanes, and other silicone compounds to be absent.

Preferably, metal artifacts may be dipped in the sealing solution for at least about one minute. While a post bake is not necessary, an attractive, glossy coating can be achieved by a postbake at temperatures of about 250⁰-400° F.

Further in accordance with this invention, a method is provided for protecting a zinc surface of a metal artifact, which comprises the following steps:
1. Passivating the surface with an oxidizing acid passivating solution, in a manner and pH similar to that described above; or activating the surface as described above;
2. Applying to the surface an aqueous priming solution of an alkali metal permanganate, a soluble rare earth metal salt such as cerium chloride, cerium acetate, cerium sulfate, or cerium nitrate, and a soluble aluminum salt such as aluminum chloride, with the solution having a pH of about 1-8, and then preferably
3. Further applying to the surface the aqueous sealing solution of a lithium silicate and another alkali metal silicate, optionally with a promoter such as molybdic acid, as previously described.

In both this aqueous sealing solution and the similar solution of the previous embodiment, the term “silicate” is intended to encompass polysilicates as well as silicates, so that the lithium, sodium, or potassium compounds can be either a silicate or a polysilicate.

As before, the three solutions can be sequentially applied to the metal artifact by immersion, with optional water rinsing, preferably with a drying step between immersion phases, with or without heating to accelerate the drying process, and steps 1 and 2 may be combined. As before, the alkali metal permanganate is typically potassium permanganate or sodium permanganate.

Furthermore, this process may also be performed at essentially room temperature of about 50-80° F., but if desired the priming solution may be heated to a temperature of about 100-180° F. The length of dipping or immersing of the metal artifact into the priming solution may preferably be about 10 to 30 seconds, but longer times may be used if desired.

The aqueous sealing solution may be the same as in the previous embodiment, with the metal artifact being immersed typically for at least one minute.

While cerium salts and particularly cerium chloride, cerium sulphate or cerium nitrate are specifically used in this disclosure, it is believed that essentially all other rare earth elements, in salt form, such as the chloride, may be used in the formulation of this invention.

The passivating solution for both processes described above may comprise about 5-30 grams per liter of oxalic acid at a pH of about 1-3, or another oxidizing acid such as nitric acid may be used at similar pH.

By adding 0.5 g/L. of cerium sulfate, I rapidly obtain a very adherent, dark yellow/iridescent color that closely resembles that of hexavalent chromium.

Additionally, one may add to the sealer solution an ethylene wax or other kind of wax to reduce the coefficient of friction on threaded products, to improve them for automotive applications. Optionally, from 25 to 200 grams per liter may be added to the sealer solution.

The examples below and other disclosure of this application are provided for illustrative purposes only, and are not intended to limit the scope of the invention of this application, which is as defined in the claims below.

All metal articles described were processed in the same way prior to treatment as described in the examples, as follows: Steel articles were either electroplated in a production zinc electroplating solution of the potassium chloride type under actual production conditions, or zinc/nickel alloy solution was used. The zinc plating solution was operated according to instructions from the manufacturer: Straus Chemical Corp. of Elk Grove Village, Ill. The average thickness of the zinc plating was from 8 to 12 microns. The articles that were plated in zinc/nickel were plated under actual production conditions from a zinc/nickel alloy solution supplied by Straus Chemical Corp. The zinc/nickel solution is of the mildly acid chloride type. The average nickel content of the zinc/nickel alloy coating was ascertained to be at 12% nickel and 88% zinc as tested by x-ray fluorescence, and had a thickness of 8-12 microns.

Oxidizing and passivation solutions tend to blacken zinc/nickel alloys, so it may be desirable to use actuating solutions with them, for example an HCl solution of pH 1.5.

### EXAMPLE I

A quantity of #10 diameter steel fasteners were electroplated with an average of 10 microns of zinc. They were then dipped in a passivating solution of 10 g/L Oxalic Acid adjusted to a pH of 1.5 with 42° Baume' Nitric acid for 45 seconds. After thorough cold water rinsing the fasteners were then dipped in a priming solution consisting of 10 g/L. potassium permanganate and 6 g/L. aluminum chloride at a pH of 2.5, adjusted with Nitric acid. The temperature of the priming solution was 140° F., and dipping time was 20 seconds. The fasteners turned a golden yellow color.

After thorough water rinsing and spin drying, the fasteners were subjected to a neutral salt spray per ASTM B 117 for 120 hours, as is required by automotive specifications. At the end of this period, the parts were totally covered with copious amounts of red rust, showing inadequate corrosion protection.

### EXAMPLE II

A quantity of the same fasteners prepared by the process of Example I were further dipped in an aqueous sealing solution of lithium polysilicate in a concentration to provide 3.33 wt. percent of SiO₂ to the total solution (Kasil #6 from PQ Industries); potassium silicate in a concentration to provide another 3.33 wt. percent of SiO₂ to the total solution (Luddox LPS from W. R. Grace); and 0.25 g/L. molybdic acid, for one minute. The solution was prepared from 100 parts by weight each of lithium polysilicate and potassium silicate solutions, each having 20 wt. percent SiO₂, plus 300 parts by weight of water, the resulting sealing solution having a total of essentially 6.67 wt. percent SiO₂. The parts were then dried without rinsing in a typical spin dryer used in the production of zinc plated fasteners for 2 minutes, with no heat applied. The fasteners were then subjected to 120 hours of salt spray testing as in Example I, and showed no signs of white corrosion.

### EXAMPLE III

A quantity of zinc plated steel fasteners, were processed as in Example I, except that the priming solution of potassium permanganate and aluminum chloride was at ambient room temperature. The fasteners were then treated with sealing solution as in Example II, and subjected to 120 hours to neutral salt spray. They showed slight signs of white corrosion as in Example II.

### EXAMPLE IV

A quantity of zinc plated fasteners were processed in a similar fashion as in Example III, except that ½ gram per liter of cerium sulphate was added to the room temperature potassium permanganate priming solution. The resulting fasteners exhibited a distinct, iridescent red/yellow/green hue that looked very much like the colors derived from a typical hexavalent chromium plated object containing passivation. The fasteners were subjected to 120 hours of neutral salt spray and exhibit no signs of any white corrosion at all.

### EXAMPLE V

A quantity of zinc plated fasteners as above were processed as in Example IV, except that the potassium permanganate/cerium sulphate solution was at 140° F., and a dipping time of 10 seconds was used. The fasteners exhibited the same color as in Example IV, and also showed no signs of white corrosion after 120 hours of salt spray testing.

### EXAMPLE VI

A quantity of fasteners as from the above examples were plated in a zinc/nickel alloy bath as described above. The fasteners were processed first by dipping in an activating bath of 2% H₂SO₄, followed by immersion in the cerium/permanganate solution of Example IV. The fasteners exhibited a distinctive, iridescent yellow color. The fasteners were then sealed in the sealing solution of Example II and dried. Upon being subjected to 120 hours of neutral salt spray, they showed no signs of white corrosion.

### EXAMPLE VII

A quantity of zinc plated fasteners were processed as in Example IV, except that the Oxalic Acid was replaced by 20 grams per liter of 42° Baume nitric acid as the passivation solution. The resulting fasteners showed no signs of white corrosion product after 120 hours of neutral salt spray testing.

### EXAMPLE VIII

A quantity of zinc plated steel fasteners were activated in a 2 percent solution of sulfuric acid, and then immersed in a solution of 10 grams per liter of potassium permanganate and 6 grams per liter of sodium chloride (common salt), adjusted to a pH of 2.0 with technical grade nitric acid, at a temperature of 140° F. The duration of immersion was 30 seconds. The fasteners were then immersed in a sealing solution containing sodium silicate and lithium polysilicate for a period of about one minute, and dried at room temperature. The sodium silicate and lithium polysilicate were each present in a concentration to each provide about 3.33 wt. percent of SiO₂ to the solution, for a total of about 6.67 wt. percent SiO₂ in the resulting solution.

The fasteners were tested as in the previous examples. After 120 hours of neutral salt spray testing, no white corrosion was observed.

### EXAMPLE IX

A quantity of zinc plated 10 mm diameter steel bolts was processed as in Example VIII, except that 50 grams per liter of polyethylene wax were added to the sealer solution. After such treatment, these bolts were tested for their torque tension properties on an RS Laboratory Torque/Tension Testing Apparatus, and were found to conform with the requirements of the Ford Torque Tension Standard WZ101. After this testing, the parts were salt spray tested for 120 hours as in the previous examples, and they exhibited no signs of white corrosion.

### EXAMPLE X

A quantity of No. 10 diameter steel fasteners were electroplated with zinc and activated in hydrochloric acid at a pH of 1.5 to remove all residual oxides. After thorough cold water rinsing, the fasteners were dipped in a solution of 5 grams per liter of potassium permanganate and 10 grams per liter of sodium chloride, at a pH of 2.5 by the addition of nitric acid. Some of the fasteners were dipped for about 15 seconds, while the potassium permanganate-sodium chloride solution was at room temperature. The experiment was also repeated with a 15 second dip of other fasteners while the solution was at 140° F.

The dried fasteners were then dipped in the sealing solution of Example II for one minute, with the solution being at room temperature. The parts were then dried without rinsing in a typical spin dryer, as in Example II.

Following this, the respective fasteners were subjected to 120 hours of salt spray testing in the manner described in Example I. Essentially no white corrosion was noted on either set of fasteners after the 120 hour test period.

The fasteners were then tested for 500 hours in the same salt spray tester. No red corrosion was noted on the fasteners after that period of time, although white corrosion was present.

EXAMPLE XI

A quantity of zinc plated fasteners were processed as in Example IV, except that the first passivation step with oxalic acid (Example 1) was omitted. The fasteners took on a darkish brown color, but did not exhibit a distinctive, iridescent color. After 120 hours of neutral salt spray testing the fasteners exhibited white corrosion products on sharp edges and recesses.

### EXAMPLE XII

Zinc plated steel fasteners were immersed in an aqueous solution of 0.3 gram per liter of potassium permanganate, adjusted to pH 1.5 with nitric acid. It should be noted that this solution performs both the function of the oxidizing acid passivation solution, as well as the permanganate priming solution, combined in one solution, since nitric acid, an oxidizing acid, is present at low pH, along with the potassium permanganate.

Following this, the fasteners were allowed to dry, and placed in the sealing solution described in Example II for one minute. They were then removed and spun dry as in Example II.

The fasteners were then subjected to 120 hours of salt spray testing as in Example I, and showed no signs of white corrosion after 120 hours.

1. A method for protecting a zinc surface of a metal artifact, which comprises:
passivating the surface with an acid passivating solution; or activating the surface with an acid activating solution;
applying to the surface an aqueous priming solution of an alkali metal permanganate in the presence of halide ion, said solution having a pH of about 1 to 8;
and then further applying to the surface an aqueous sealing solution.

2. The method of claim 1 in which said sealing solution comprises a mixture of a lithium silicate and another alkali metal silicate in a concentration to provide from 5 to 20 wt. percent of SiO₂ to said sealing solution, with each of said lithium silicate and other alkali metal silicate providing at least 10 percent of the SiO₂ to the sealing solution.

3. The method of claim 1 in which said acidic passivating solution is used, which solution comprises a solution of nitric acid, oxalic acid, or a combination thereof.

4. The method of claim 1 in which the pH of the priming solution is about 1.5 to 5.

5. The claim of claim 1 in which said halide ion is chloride.

6. The method of claim 1 in which said alkali metal permanganate is potassium permanganate.

7. The method of claim 1 in which the passivating or activating solution, the priming solution, and the sealing solution are all applied to the metal artifact by sequential dipping.

8. The method of claim 1 in which said halide ion is provided to the priming solution in the form of a alkali metal chloride.

9. The method of claim 1 which is performed at a temperature of about 50-80° F.

10. The method of claim 1 in which said priming solution is heated to a temperature of 100°-180° F.

11. The method of claim 1 in which said priming solution is applied to the metal artifact by dipping the metal artifact into said solution for at least 5 seconds.

12. The method of claim 11 in which said priming solution is applied to the metal artifact by dipping for about 10 to 30 seconds.

13. The method of claim 1 in which said aqueous sealing solution comprises lithium polysilicate, potassium silicate, and about 0.2 to 0.5 gram per/liter of a molybdic acid promoter.

14. The method of claim 13 in which the metal artifact is dipped in the sealing solution for at least about one minute.

15. A method for protecting a zinc surface of a metal artifact, which comprises:
passivating the surface with an acid passivating solution or activating the surface with an acid activating solution;
applying to the surface an aqueous priming solution of an alkali metal permanganate, a soluble rare earth metal salt, and a soluble aluminum salt, said solution having a pH of about 1 to 6, adjusted with nitric acid.

16. The method of claim 15, further comprising the subsequent step of applying to the surface an aqueous sealing solution with comprises a lithium silicate and another alkali metal silicate in a concentration to provide from 5 to 20 wt. percent of SiO₂ to said sealing solution, with each of said lithium silicate and other alkali metal silicate providing at least 10 percent of the SiO₂ to the sealing solution.

17. The method of claim 16 in which a promoter is also added to the sealing solution.

18. The method of claim 15 in which the pH of the priming solution is essentially 1.5 to 5.

19. The method of claim 15 in which said aluminum salt is aluminum chloride.

20. The method of claim 15 in which the alkali metal permanganate is potassium permanganate.

21. The method of claim 15 in which the passivating or activating solution and the priming solution are all applied to the metal artifact by sequential dipping.

22. The method of claim 15, which is performed at a temperature of about 50-80° F.

23. The method of claim 15 in which said passivating solution comprises about 5 to 30 gm./liter of oxalic acid at a pH of about 1-3.

24. The method of claim 15 in which said priming solution is applied to the surface by dipping said metal artifact into the priming solution heated to a temperature of 100°-180° F. for a period of about 10 to 30 seconds.

25. The method of claim 16 in which said aqueous sealing solution comprises lithium polysilicate, potassium silicate, and about 0.2 to 0.5 gm/liter of molybdic acid.

26. The method of claim 16 in which the metal artifact is dipped in the sealing solution for at least about one minute.

27. The method of claim 15 in which said rare earth metal is cerium.

28. The method of claim 15 in which said rare earth metal salt is cerium chloride or cerium sulphate.

29. The method of claim 1 in which said priming solution contains a soluble rare earth metal salt.

30. The method of claim 29 in which said rare earth metal is cerium.

31. A method for protecting a zinc surface of a metal artifact, which comprises:
passivating the surface with a solution comprising an oxidizing acid, or activating the surface with an acid activating solution;
applying to the surface an aqueous priming solution of an alkali metal permanganate and an alkali metal halide, said solution having a pH of about 1 to 6;
and then further applying to the surface an aqueous sealing solution of a lithium silicate, and a sodium or potassium silicate.

32. The method of claim 31 in which a promoter is also present in said sealing solution.

33. The method of claim 31 in which the alkali metal permanganate is potassium permanganate.

34. The method of claim 31 in which the solutions are all applied to the metal artifact by sequential dipping.

35. The method of claim 31 in which said aqueous sealing solution comprises a lithium silicate and another alkali metal silicate in a concentration to provide from 5 to 20 wt. percent of SiO₂ to said sealing solution, with each of said lithium silicate and other alkali metal silicate providing at least 10 percent of the SiO₂ to the sealing solution, and about 0.2 to 0.5 gram per liter of molybdic acid.

36. The method of claim 1 in which said acid passivating solution is used.

37. A metal artifact, made by the process of claim 1.

38. A metal artifact, made by the process of claim 16.

39. A metal artifact, made by the process of claim 31.

40. The method of claim 1 in which said artifact is thereafter postbaked at 250° to 400° F. to achieve a glossy coating.
